(19) United States
(12) Patent Application Publication
(10) Pub. No.: US 2015/0349663 A1
(43) Pub. Date: Dec. 3, 2015

(54) Power Conversion Apparatus

(71) Applicant: Hitachi, Ltd., Tokyo (JP)

(72) Inventors: Hiromu KAKUYA, Tokyo (JP); Eiichi SUZUKI, Tokyo (JP)

(21) Appl. No.: 14/725,665

(22) Filed: May 29, 2015

(30) Foreign Application Priority Data
Jun. 3, 2014 (JP) 2014-114493

(51) Int. Cl. H02M 7/5387

(52) U.S. Cl. CPC H02M 7/53871

(57) ABSTRACT

The power conversion apparatus includes a DC to AC conversion device which enables conversion between a DC voltage and an AC voltage, periodically changes a magnitude of a DC voltage of the DC to AC conversion device according to a period of a voltage of the interconnected AC voltage system, and allows a portion of an output AC voltage to be substituted with the periodic change in the DC voltage so as to be output, in which means for controlling the DC voltage according to a phase having the highest successive amplitude among three-phase AC voltages which are voltages of the interconnected AC voltage system.

### CLAIM OF PRIORITY

The present application claims priority from Japanese patent application JP2014-114493 filed on Jun. 3, 2014, the content of which is hereby incorporated by reference into this application.

### TECHNICAL FIELD

The present invention relates to a power conversion apparatus.

### BACKGROUND ART

As the background art related to the technical field, for example, there is a technique disclosed in PTL 1.

In PTL 1, a technique is disclosed in which a first matching circuit which detects three-phase output voltages of an uninterruptible power source device and obtains a deviation between an average value of three-phase full-wave rectified voltages and a predetermined setting voltage, a second matching circuit which detects each phase voltage of three-phase outputs of the uninterruptible power source device and obtains a deviation between each average value of individually single-phase full-wave rectified voltages and the setting voltage for each phase, and an adder which adds the deviation output of the first matching circuit to each phase deviation power of the second matching circuit tor each phase are included, individual gate signals for the three phases are generated on the basis of each phase output signal of the adder and three-phase sine wave signals with 120° phase difference, and an inverter of the uninterruptible power source device is controlled by the gate signals.

### CITATION LIST

### Patent Literature

PTL 1: JP-A-6-38538

### SUMMARY OF INVENTION

### Technical Problem

In recent years, there have been concerns over global warming and fossil fuel depletion due to carbon dioxide emissions, and thus a reduction of the amount of emitted carbon dioxide and a reduction in the dependence on fossil fuels are required. In order to achieve a reduction in the amount of emitted carbon dioxide and a reduction in the dependence on fossil fuels, it is thought that the introduction of a power generation system which, uses renewable energy obtained, from nature, such as wind power or sunlight, is effective.

Power is transmitted from a power plant that generates power to consumers via a power system. However, the power is transmitted in the form of an AC voltage having the maximum amplitude in a predetermined period. Power generated using the renewable energy needs to be matched with the voltage of the power system in amplitude and phase in order to transmit the power. Therefore, equipment connected to the power system is generally provided with, in addition to the renewable energy, a power conversion apparatus, particularly a DC to AC conversion device which enables conversion between a DC voltage and an AC voltage.

In addition, as the power conversion apparatus, an apparatus is widely used which uses a semiconductor device that is provided in a power circuit and enables connection to and disconnection from the power. Power conversion from DC to AC is achieved by performing a large number of switching operations of the semiconductor device.

As described above, in a case where the power conversion apparatus is used for connection to the power system in order to transmit and receive (interconnect) power, the amplitude anaphase of the voltage of the power system need to be matched. However, regarding the three-phase AC voltages of the power system, there may be cases where there are deviations between the three phases in amplitude and phase (three-phase imbalance) depending on the state of a load, connected thereto.

In PTL 1, in order to cope with the three-phase imbalance, a control technique of adjusting the switching pattern of the power conversion apparatus according to the deviations is disclosed. By using the technique disclosed in PTL 1, the power conversion apparatus outputs a voltage matched with the three-phase imbalance of the power system and thus can transmit and receive a desired amount of power.

When the power conversion apparatus performs switching operations, power loss occurs. In order to maximize the utilization of renewable energy with a low investment, a technique of reducing switching loss of the power conversion apparatus is essential. According to the control technique disclosed in PTL 1, the control technique can cope with the three-phase imbalance of the power system. However, a technique of reducing power loss of the power conversion apparatus is not disclosed, and there is a problem in that the power loss of the power conversion apparatus cannot be reduced.

### Solution to Problem

The present invention has a plurality of solutions to solve the representative problem. As the representative solving means, there is provided, a power conversion apparatus including; a DC to AC conversion circuit which enables conversion between a DC voltage and an AC voltage, in which the power conversion apparatus periodically changes a magnitude of a DC voltage which is a voltage of a DC side connection end of the DC to AC conversion circuit according to a period of a voltage of an AC voltage system connected to an AC side connection end of the DC to AC conversion circuit, and allows a portion of an AC voltage which is a voltage of the AC side connection end to be substituted with the periodic change in the DC voltage so as to be output, and the DC voltage is controlled according to a voltage of a phase having the highest successive amplitude among three-phase AC voltages which are voltages of the AC voltage system.

### Advantageous Effects of Invention

According to the representative solving means of the present invention, a power conversion apparatus capable of enhancing the efficiency of the power conversion apparatus by reducing power loss caused by switching operations of the power conversion apparatus while adjusting voltages and currents output according to three-phase imbalance of the power system interconnected with the power conversion apparatus can be provided.

### BRIEF DESCRIPTION OF DRAWINGS

FIG. 1 is a system block diagram illustrating the schematic configuration of a first embodiment of a power conversion apparatus of the present invention.

FIG. 2 is a circuit diagram illustrating the schematic configuration of a DC to AC conversion circuit 2 of the first embodiment of the power conversion apparatus of the present invention.

FIG. 3 is a circuit diagram illustrating the schematic configuration of a DC voltage conversion circuit 3 of the first embodiment of the power conversion apparatus of the present invention.

FIG. 4 illustrates a control algorithm mounted in a control device 1 of the first embodiment of the power conversion apparatus of the present invention.

FIG. 5 is a time chart illustrating the summary of operating states of a command voltage 1 calculation 41 and a maximum amplitude 1 calculation 43 in the first embodiment of the power conversion apparatus of the present invention.

FIG. 6 is a time chart illustrating the summary of operating states of a command voltage 2 calculation 42 and a maximum amplitude 2 calculation 44 in the first embodiment of the power conversion apparatus of the present invention.

FIG. 7 is a time chart illustrating the summary of operating states of an amplitude ratio calculation 45 and an amplitude threshold 1 calculation 46 in the first embodiment of the power conversion apparatus of the present invention.

FIG. 8 is a time chart illustrating the summary of operating states of maximum amplitudes and amplitude thresholds 1 during three-phase balance and during three-phase imbalance in the first embodiment of the power conversion apparatus of the present invention.

FIG. 9 is a time chart illustrating the summary of operating states of an A phase of a switching pattern calculation 47 in the first embodiment of the power conversion apparatus of the present invention.

FIG. 10 is a time chart illustrating the summary of operating states of a B phase of the switching pattern calculation 47 in the first embodiment of the power conversion apparatus of the present invention.

FIG. 11 is a time chart illustrating the summary of operating states of a C phase of the switching pattern calculation 47 in the first embodiment of the power conversion apparatus of the present invention.

FIG. 12 illustrates a control algorithm mounted in the control device 1 of a second embodiment of the power conversion apparatus of the present invention.

FIG. 13 is a time chart illustrating the summary of operating states of the amplitude ratio calculation 45 and an adjustment flag calculation 121 in the first embodiment of the power conversion apparatus of the present invention.

FIG. 14 is a time chart illustrating the summary of operating states of an A phase of a switching pattern calculation 122 in the second embodiment of the power conversion apparatus of the present invention.

FIG. 15 is a time chart illustrating the summary of operating states of a B phase of the switching pattern calculation 122 in the second embodiment of the power conversion apparatus of the present invention.

FIG. 16 is a time chart illustrating the summary of operating states of a C phase of the switching pattern calculation 122 in the second embodiment of the power conversion apparatus of the present invention.

FIG. 17 is a system block diagram illustrating the schematic configuration of a third embodiment of the power conversion apparatus of the present invention.

### DESCRIPTION OF EMBODIMENTS

Embodiments of the present invention will be described.

### Application of the Invention

The embodiments described below can be applied to a power conversion apparatus including a DC to AC conversion device which enables conversion between DC and AC and a conversion device which is able to operate a DC voltage which is a voltage of the DC side of the DC to AC conversion device.

More specifically, the embodiments can be applied to a storage battery system, a reactive power compensation system, a photovoltaic power generation system, and the like provided with the power conversion apparatus including the DC to AC conversion device and a DC to DC conversion device.

Moreover, the embodiments can also be applied to an AC to AC conversion system, a wind-power generation system, and the like provided with a circuit configuration including a DC to AC conversion device connected to the DC to AC conversion device on the DC side.

### Schematic Configuration of Power Conversion Apparatus

The power conversion apparatus is an apparatus which converts DC power into AC power or converts AC power into DC power. There may be cases where a DC power source is connected to the DC side of the power conversion apparatus and an AC voltage system is connected to the AC side thereof for interconnection. In addition, there may be cases where an AC load represented by an electric motor or a generator is connected to the AC side thereof.

In addition, as the power conversion apparatus, there is also an apparatus having a configuration that can convert AC power into AC power. There may be cases where an AC voltage system is connected to the AC side at one end thereof and an AC voltage system is also connected to the AC side at the other end thereof for interconnection. In addition, there may be cases where an AC voltage system is connected to the AC side at one end thereof and an AC load represented by an electric motor or a generator is connected to the AC side at the other end thereof.

### Representative Operational Effects by Solving Means

Moreover, there are problems to be solved and solving means. These are substituted with effects which are contrary to the problems in each of the following embodiments and will be described together with the solving means.

Hereinafter, the embodiments of the present invention will be described in detail with reference to the drawings.

### First Embodiment

### Schematic Configuration of First Embodiment

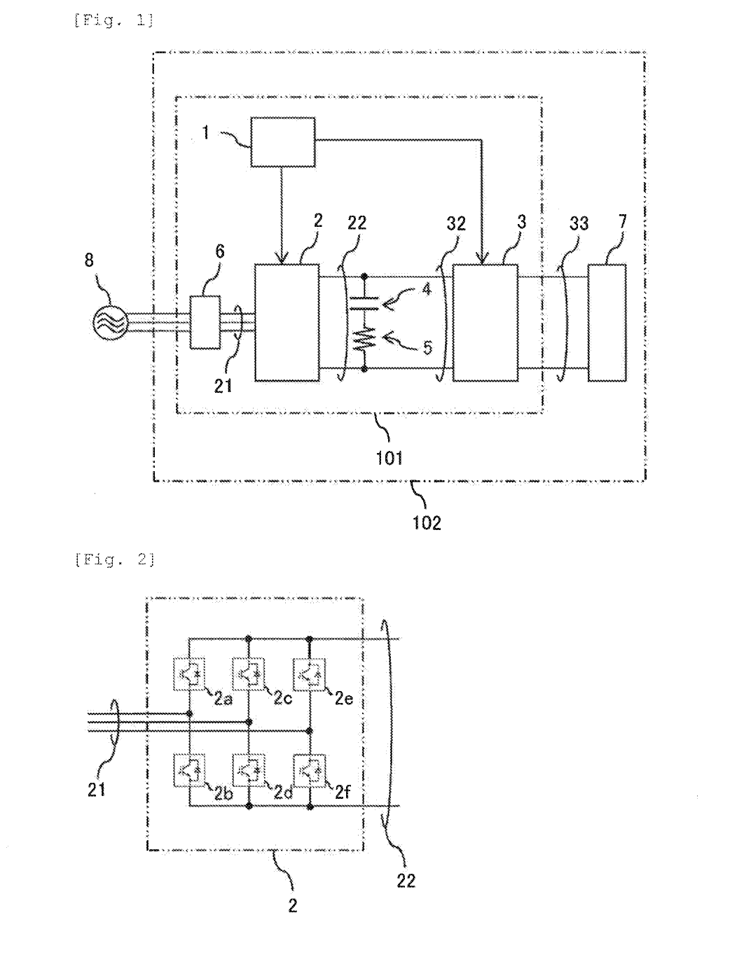

First, the schematic configuration of a first embodiment of the power conversion apparatus according to the present invention will be described with reference to FIG. 1.

FIG. 1 illustrates the schematic configuration of the entirety of a power system 102 to which a power conversion apparatus 101 of the present invention is applied.

The power conversion apparatus 101 includes a control device 1, a DC to AC conversion circuit 2 which enables conversion between DC and AC, a DC voltage conversion circuit 3 which can convert DC to DC, a serial string including a capacitor 4 and a resistor 5 which are connected in parallel to a DC side terminal 22 of the DC to AC conversion circuit 2 or a terminal 32 that is the connection terminal of the DC voltage conversion circuit 3, and a filter circuit 6 connected to an AC side terminal 21 of the DC to AC conversion circuit 2.

Although not clearly illustrated in FIG. 1, the power conversion apparatus 101 includes a sensor that detects the control device and the external state, and in the control device 1, a control program is mounted in advance which calculates and outputs a signal for changing the operating state of the DC to AC conversion circuit 2 or the operating state of the DC voltage conversion circuit 3 on the basis of the output signal of the sensor.

A DC power source device 7 is connected to a connection terminal 33 of the DC voltage conversion circuit 3 of the power conversion apparatus 101. Although not clearly illustrated in FIG. 1, a configuration in which a lead battery, a lithium ion secondary battery, a nickel-hydrogen battery, a fuel cell, a capacitor, a DC power source device, or a solar cell is connected thereto in series or in parallel, or a configuration in which a plurality of types thereof are connected thereto in series or in parallel may be employed.

Furthermore, the power conversion apparatus 101 is connected to an AC voltage system 8 via the filter circuit 6 such that power transmission between the power system 102 and the AC voltage system 8 is performed. Although not clearly illustrated in FIG. 1, the filter 6 is provided with a reactor or a capacitor at an appropriate position and has an appropriate circuit configuration.

Hereinafter, in this embodiment, details are described by exemplifying a system which generates three-phase AC voltages as the AC voltage system 8. However, an AC voltage load such as a generator may also be connected thereto.

### Configuration of DC to AC Conversion Circuit in First Embodiment

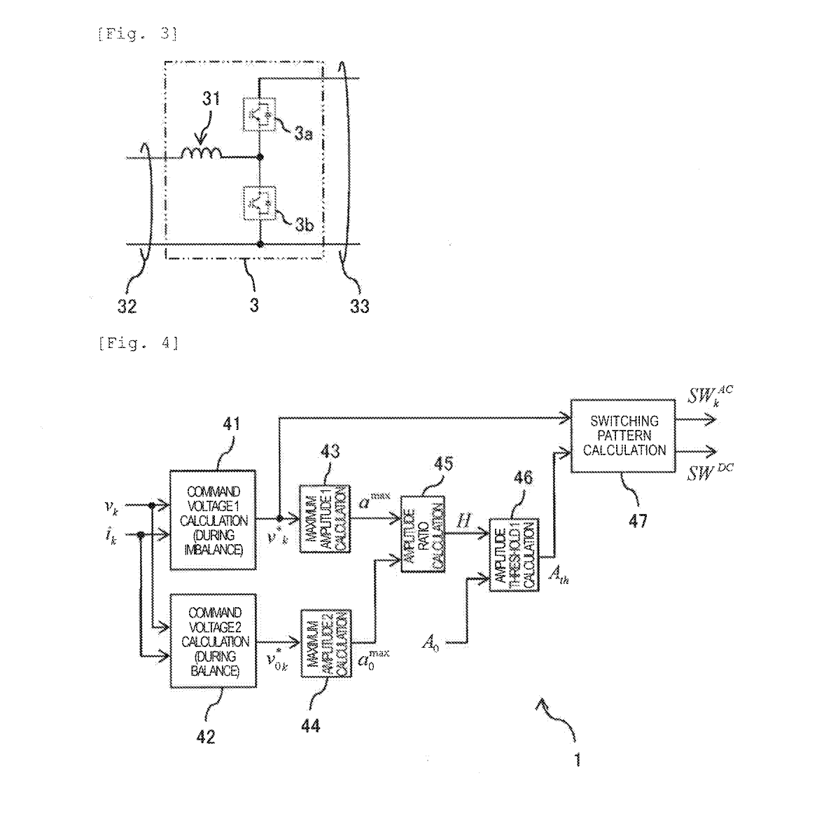

FIG. 2 illustrates the schematic configuration of the DC to AC conversion circuit 2 included in the power conversion apparatus 101 of FIG. 1.

The DC to AC conversion circuit 2 includes the AC side terminal 21 which is a terminal connected to the AC side and the DC side terminal 22 which is a terminal connected to the DC side.

In addition, the DC to AC conversion circuit 2 includes pairs of switches 2a, 2b, 2c, 2d, 2e, and 2f in which a semiconductor switch such as an IGBT (Insulated Gate-emitted Bipolar Transistor) and a diode are connected in parallel. Each of the switches 2a and 2b, 2c and 2d, and 2e and 2f forming the pairs are connected in series, and 2 series terminals are connected in parallel and are connected to the DC side terminal 22. In addition, each of the midpoints of the pairs of switches as 2 series is connected to the AC side terminal 21. The DC to AC conversion circuit 2 has a fall-wave bridge converter circuit configuration which can convert a DC voltage connected to the DC side terminal 22 into three-phase AC voltages so as to be output from the AC side terminal 21.

### Configuration of DC Voltage Conversion Circuit in First Embodiment

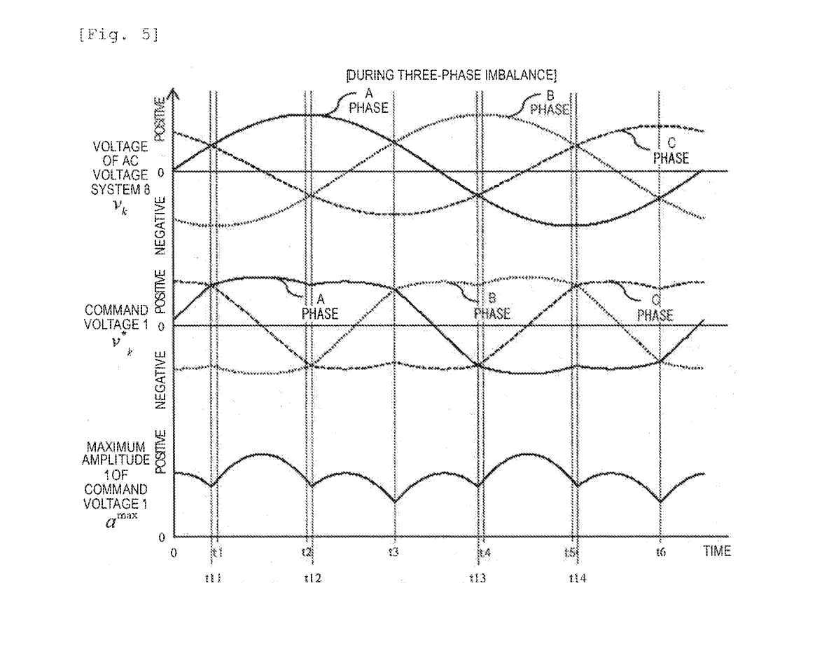

FIG. 3 illustrates the schematic configuration of the DC voltage conversion circuit 3 included in the power conversion apparatus 101 of FIG. 1.

The DC voltage conversion circuit 3 includes a reactor 31, a pair of switches 3a and 3b having the same configuration as those of the above-described pairs of switches 2a, 2b, 2c, 2d, 2e, and 2f, a low voltage side terminal 32, and a high voltage side terminal 33.

The switches 3a and 3b forming the pair are connected in series, and the terminals after the series connection constitute the high voltage side terminal 33. The terminal having a positive voltage when a voltage is applied in a direction opposite to the diodes included in the pair of switches 3a and 3b is a positive side terminal of the high voltage side terminal, and the terminal having a negative voltage when the voltage is applied in the direction opposite to the diodes is a negative side terminal of the high voltage side terminal.

A terminal connected to the midpoint of the pair of switches 3a and 3b and a terminal connected to the negative side terminal of the high voltage side terminal described above, which form a pair, constitute the low voltage side terminal 32. The terminal connected to the midpoint of the pair of switches 3a and 3b described above via the reactor 31 is a positive side terminal of the low voltage side terminal 32, and the terminal connected to the negative side terminal of the high voltage side terminal 33 described above is a negative side terminal of the low voltage side terminal 32.

The DC voltage conversion circuit 3 illustrated in FIG. 3 has a circuit configuration which enables bidirectional transmission of DC power between a DC voltage source A connected to the low voltage side terminal 32 and a DC voltage source B connected to the high voltage side terminal 33 and has the same configuration as the circuit configuration of a portion of a non-isolated type bidirectional DC-DC converter. In addition, a relationship in which the voltage of the DC power source A is lower than the voltage of the DC power source B needs to be satisfied.

In the first embodiment, the DC voltage conversion circuit 3 of the power conversion apparatus 101 has the configuration illustrated in FIG. 3. However, the first embodiment is not limited thereto, and connection in the direction opposite to that of FIG. 1 such as connection of the high voltage side terminal 33 to the DC side terminal 22 of the DC to AC conversion circuit 101 may also be employed. In addition, as described above, the DC voltage conversion circuit 3 of FIG. 3 is of a non-isolated type. However, the DC voltage conversion circuit 3 may also have the same circuit configuration as that of an isolated type DC/DC converter.

### Description of Operations of Power Conversion Apparatus in First Embodiment

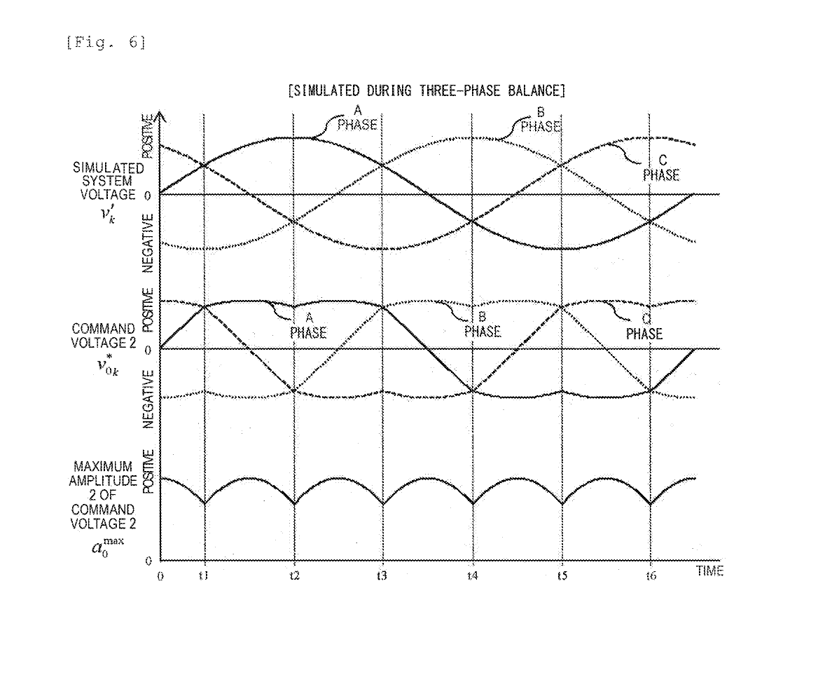

Next, an example of the operations of the power conversion apparatus 101 will be described with reference to FIGS. 4 to 11.

FIG. 4 illustrates a block diagram of a control algorithm mounted in the control device 1 of the power conversion apparatus 101.

The control algorithm in the first embodiment is formed by a command voltage 1 calculation 41, a command voltage 2 calculation 42, a maximum amplitude 1 calculation 43, a maximum amplitude 2 calculation 44, an amplitude ratio calculation 45, an amplitude threshold 1 calculation 46, and a switching pattern calculation 47.

Although not clearly illustrated in FIG. 1, the command voltage 1 calculation 41 calculates a command voltage 1 (v*ₖ) which is a command voltage for determining the switching pattern of the DC to AC conversion circuit 2 to enable power transmission between the AC voltage system 8 and the DC to AC conversion, circuit 2 during three-phase imbalance on the basis of vₖ (k is a three-phase number A, B, or C) which is an output signal of a voltage sensor that measures the voltage of the AC voltage system 8 and iₖ which is an output signal of a current sensor that measures the three-phase current. Although not clearly illustrated in FIG. 4, the above-mentioned command voltage 1 is calculated by feed-back control based on a target current determined by a target power value output from the power conversion apparatus 101 and the three-phase current (iₖ).

Although not clearly illustrated in FIG. 1, the command voltage 2 calculation 42 calculates a command voltage 2 (v*₀ₖ) which is a command voltage for determining the switching pattern of the DC to AC conversion circuit 2 to enable power transmission between the AC voltage system 8 and the DC to AC conversion circuit 2 during three-phase balance on the basis of the voltage (vₖ) of the AC voltage system 8 and the three-phase current (iₖ). Although not clearly illustrated in FIG. 4, the above-mentioned command voltage 2 is calculated by feed-back control based on the target current determined by the target power value output from the power conversion apparatus 101 and the three-phase current (iₖ). More specifically, a virtual three-phase AC voltage is generated according to a voltage having the highest amplitude among three-phase voltages of the AC voltage system 8, a command voltage for transmitting and receiving the virtual three-phase AC voltage and the target power is calculated, and this command voltage is set to the command voltage 2.

The maximum amplitude 1 calculation calculates a maximum amplitude 1 (a^{max}) which is the highest successive amplitude value of the command voltage 1 (v*ₖ) on the basis of the command voltage 1 (v*ₖ). More specifically, the absolute value of the command voltage 1 (v*ₖ) is calculated, and the highest value among the three phase components is selected and is output as the maximum amplitude 1 (a^{max}).

The maximum amplitude 2 calculation calculates a maximum amplitude 2 (a₀^{max}) which is the highest successive amplitude value of the command voltage 2 (v*₀ₖ) on the basis of the command voltage 2 (v*₀ₖ) in the same manner as that of the maximum amplitude 1 calculation. More specifically, the absolute value of the command voltage 2 (v*₀ₖ) is calculated, and the highest value among the three phase components is selected and is output as the maximum amplitude 2 (a₀^{max}).

The amplitude ratio calculation 45 calculates the amplitude ratio (H) on the basis of the maximum amplitude 1 (a^{max}) and the maximum amplitude 2 (a₀^{max}). More specifically, the maximum amplitude 1 (a^{max}) with respect to the maximum amplitude 2 (a₀^{max}) is set to the amplitude ratio (H) by dividing the maximum amplitude 1 (a^{max}) by the maximum amplitude 2 (a₀^{max}).

The amplitude threshold 1 calculation 46 calculates an amplitude threshold 1 (Aₜₕ) on the basis of the amplitude ratio (H) and an amplitude threshold 2 (A₀) during three-phase balance. The amplitude threshold 2 (A₀) is a value to divide a level corresponding to the DC to AC conversion circuit 2 and a level corresponding to the DC voltage conversion circuit 3 in the command voltage 2 (v*₀ₖ) during three-phase balance. By multiplying the amplitude threshold 2 (A₀) by the amplitude ratio (H), the amplitude threshold 1 (Aₜₕ) which specifies the levels corresponding to the DC to AC conversion circuit 2 and the DC voltage conversion circuit 3 during three-phase imbalance is calculated. In addition, the amplitude threshold 2 (A₀) is held at a constant value under predetermined operating conditions. However, since the amplitude ratio (H) is successively changed, the amplitude threshold 1 (Aₜₕ) is successively changed with the successive change in the command voltage 1 (v*ₖ).

The switching pattern calculation 47 calculates a switching pattern (SWₖ^{AC}) for operating the DC to AC conversion circuit 2 and a switching pattern (SW^{DC}) for operating the DC voltage conversion circuit 3 on the basis of the command voltage 1 (v*ₖ) and the amplitude threshold 1 (Aₜₕ). First, the command voltage 1 (v*ₖ) and the amplitude threshold 1 (Aₜₕ) are compared to each other, and division into a command voltage (command voltage A) of a section in which the command voltage 2 (v*ₖ) is lower than the amplitude threshold 1 (Aₜₕ) and a command voltage (command voltage B) of a section in which the command voltage 2 (v*ₖ) is higher than the amplitude threshold 1 (Aₜₕ) is performed. Subsequently, the command voltage A and a carrier (carrier A) for the DC to AC conversion circuit 2 are compared to each other, and in a case where the command voltage A is higher than the carrier, the switching pattern (SWₖ^{AC}) is set to the ON state, and in the opposite case, the switching pattern (SWₖ^{AC}) is set to the OFF state. In addition, the command voltage B and a carrier (carrier B) for the DC voltage conversion circuit 3 are compared to each other, and in a case where the command voltage B is higher than the carrier B, the switching pattern (SW^{DC}) is set to the ON state, and in the opposite case, the switching pattern (SW^{DC}) is set to the OFF state.

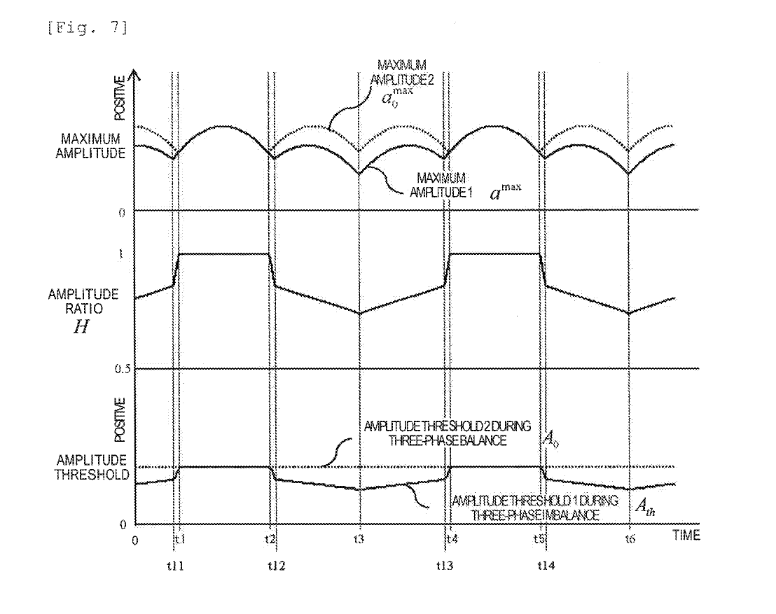

FIG. 5 is a time chart illustrating the summary of operating states of the command voltage 1 calculation 41 and the maximum amplitude 1 calculation 43 in the first embodiment of the power conversion apparatus of the present invention. FIG. 5 illustrates the voltage (vₖ) of the AC voltage system 8 during three-phase imbalance, the command voltage 1 (v*ₖ) which is a calculation result of the command voltage 1 calculation 41, and the maximum amplitude 1 (a^{max}) of the command voltage 1 which is a calculation result of the maximum amplitude 1 calculation 43. The horizontal axis of FIG. 5 represents time, and the upper parts of the chart respectively represent that the voltage 1 (vₖ) of the AC voltage system 8 is positive, the command voltage 1 (v*ₖ) is positive, and the maximum amplitude 1 (a^{max}) of the command voltage 1 is positive. In this embodiment, a case where the amplitude of only the C phase in the voltage (vₖ) of the AC voltage system 8 is low is postulated. In the command voltage 1 calculation 41, the command voltage 1 (v*ₖ) which is the superposition of voltages at a frequency which is three times the fundamental frequency is calculated on the basis of the voltage (vₖ) of the AC voltage system 8. The superposition at the third order frequency described above is called a third order harmonic injection method and is a method to enhance the utilization of the DC power of the DC to AC conversion circuit 2. In addition, in the maximum amplitude 1 calculation 43, as illustrated in the lower section of FIG. 5, the maximum value of the absolute values of the three-phase components of the command voltage 1 (v*ₖ) is calculated and is output as the maximum amplitude 1 (a^{max}).

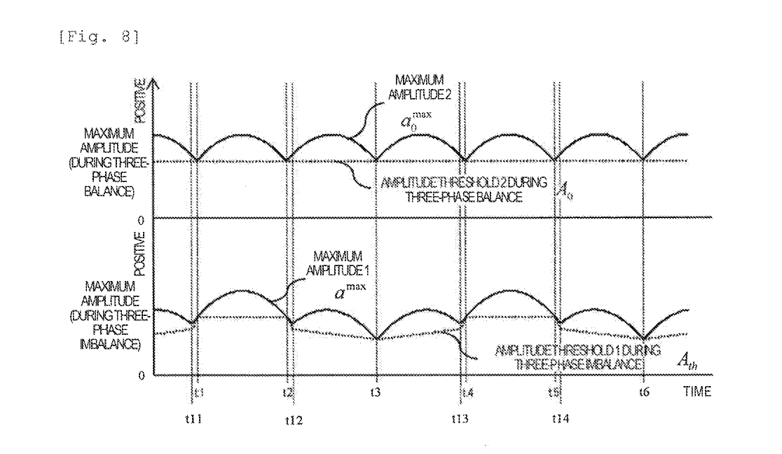

FIG 6 is a time chart illustrating the summary of operating states of the command voltage 2 calculation 42 and the maximum amplitude 2 calculation in the first embodiment of the power conversion apparatus of the present invention. The horizontal axis of FIG. 6 represents time, and the vertical axis thereof represents a simulated system voltage (v′ₖ) of the AC voltage system 8 which simulates three-phase balance, the command voltage 2 (v*₀ₖ) which is a calculation result of the command voltage 2 calculation 42, and the maximum amplitude 2 (a₀^{max}) of the command voltage 2 which is a calculation result of the maximum amplitude 2 calculation 44. The upper parts of the chart respectively represent that the simulated system voltage (v′ₖ) of the AC voltage system 8 which simulates three-phase balance is positive, the command voltage 2 (v*₀ₖ) is positive, and the maximum amplitude 2 (a₀^{max}) of the command voltage 2 is positive. First, in the command voltage 2 calculation, the simulated system voltage (v′ₖ) which simulates three-phase balance is calculated from the phase of the maximum amplitude on the basis of the voltages (v*ₖ) of the three phases of the AC voltage system 8 during three-phase imbalance. On the basis of the simulated system voltage (v′ₖ), the command voltage 2 (v*₀ₖ) is calculated by using the above-mentioned third order harmonic injection method. Since the command voltage 2 (v*₀ₖ) is calculated under the conditions in which the three-phase balance is simulated, the maximum amplitude is the same and the phases are different in a single cycle of all of the three phases. In the subsequent maximum amplitude 2 calculation 44, the absolute value of the command voltage 2 (v*₀ₖ) is obtained, and the successive maximum value is output as the maximum amplitude 2 (a₀^{max}).

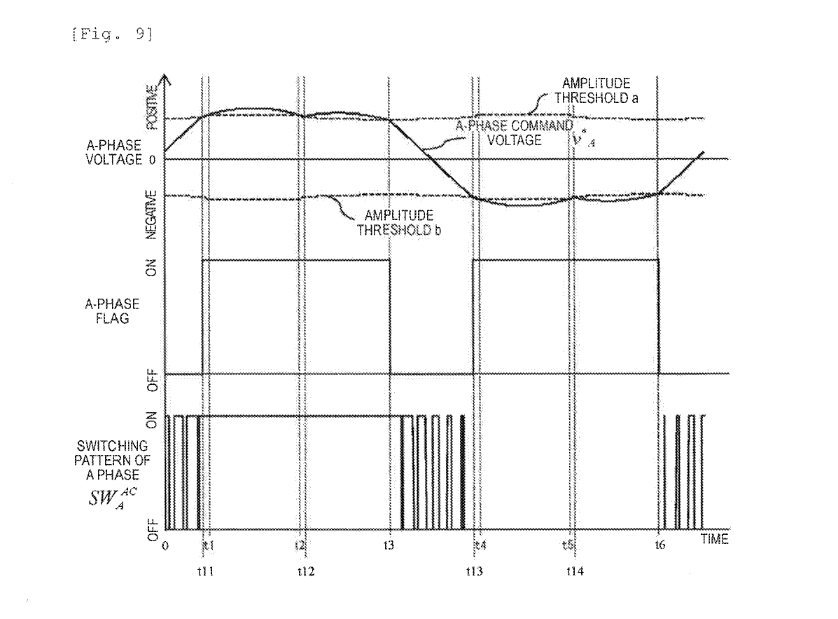

FIG. 7 is a time chart illustrating the summary of operating states of the amplitude ratio calculation 45 and the amplitude threshold 1 calculation 46 in the first embodiment of the power conversion apparatus of the present invention. The horizontal axis of FIG. 7 represents time, and the vertical axis thereof represents the maximum amplitude, the amplitude ratio, and the amplitude threshold 1. The upper parts of the chart respectively represent that the maximum amplitude is positive, the amplitude ratio is positive, and the amplitude threshold 1 is positive. The maximum amplitude illustrated in the upper section of FIG. 7 is re-illustration of the maximum amplitude 1 (a^{max}) and the maximum amplitude 2 (a₀^{max}) illustrated in FIGS. 5 and 6. As illustrated in the intermediate section of FIG. 7, in the amplitude ratio calculation 45, a result obtained by multiplying the maximum amplitude 1 (a^{max}) by the maximum amplitude 2 (a₀^{max}) is output as the amplitude ratio (H). Here, the amplitude ratio (H) represents the ratio of the maximum amplitude 1 (a^{max}) with respect to the maximum amplitude 2 (a₀^{max}). As illustrated in the lower section of FIG. 7, in the amplitude threshold 1 calculation 46, a result obtained by multiplying the amplitude threshold 2 (A₀) of the amplitude of the command voltage 2 during three-phase balance by the amplitude ratio (H) which is the calculation result of the amplitude ratio calculation 45 is output as the amplitude threshold 1 (Aₜₕ). As the difference between the maximum amplitude 1 (a^{max}) and the maximum amplitude 2 (a₀^{max}) changes with time, the amplitude threshold 1 changes with time.

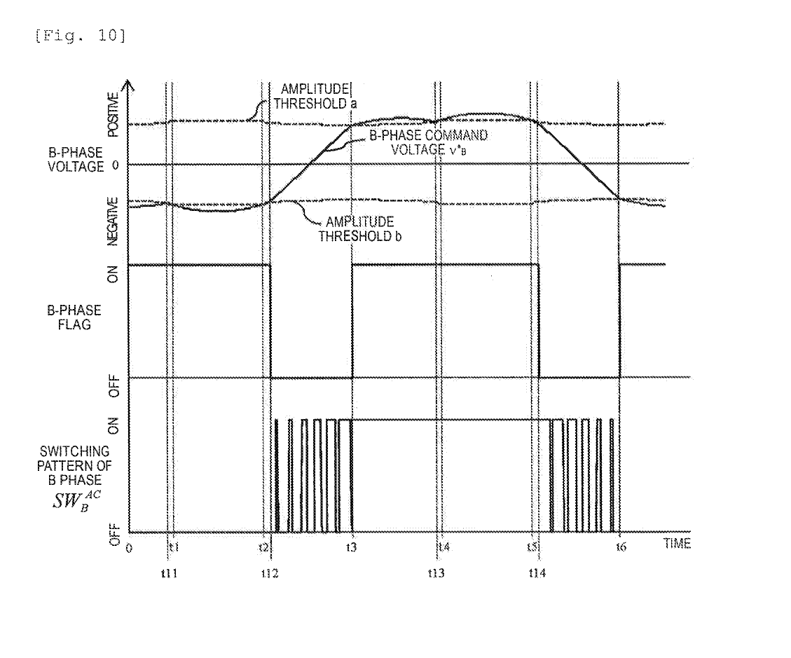

FIG. 8 is a time chart illustrating the summary of operating states of the maximum amplitudes and the amplitude thresholds during three-phase balance and during three-phase imbalance in the first embodiment of the power conversion apparatus of the present invention. The horizontal axis of FIG. 8 represents time, and the vertical axis thereof represents the maximum amplitudes. The upper parts of the chart represent that the maximum amplitudes are positive. As illustrated in the upper section of FIG. 8, in the first embodiment of the power conversion apparatus of the present invention, in a case where the voltages of the AC voltage system 8 undergo three-phase balance, the maximum amplitude 2 (a₀^{max}) is periodically changed, and the amplitude threshold 2 (A₀) has a constant value and becomes the same value as the minimum value of the maximum amplitude 2 (a₀^{max}). In addition, as illustrated in the lower section of FIG. 8, in a case where the voltages of the AC voltage system 8 undergo three-phase imbalance, the maximum amplitude 1 (a^{max}) is irregularly changed according to the command voltage 1 (v*ₖ) during the three-phase imbalance, and the amplitude threshold 1 (Aₜₕ) is also successively changed according to the change in the maximum amplitude 1 (a^{max}).

FIG. 9 is a time chart illustrating the summary of operating states of the A phase of the switching pattern calculation 47 in the first embodiment of the power conversion apparatus of the present invention. The horizontal axis of FIG. 9 represents time, and the vertical axis thereof represents an A-phase voltage, an A-phase flag, and a switching pattern (SW_{A}^{AC}) for operating the DC to AC conversion circuit 2 in the A phase. The upper parts of the chart respectively represent that the A-phase voltage is positive, the A-phase flag is in the ON state, and the switching pattern (SW_{A}^{AC}) is in the ON state. As illustrated in the upper section of FIG. 9, in the switching pattern calculation 47, an amplitude threshold a and an amplitude threshold b are calculated from the amplitude threshold 1 (Aₜₕ). A value equal to the amplitude threshold 1 (Aₜₕ) is set to the amplitude threshold a, and a value obtained by inverting the sign of the amplitude threshold 1 (Aₜₕ) is set to the amplitude threshold b. In the switching pattern calculation 47, the A-phase flag which is set to the ON state in a case where the absolute value of an A-phase command voltage (v*_{A}) is higher than the absolute values of the amplitude threshold a and the amplitude threshold b is calculated. By using the A-phase flag, in a case where the A-phase flag is in the ON state, when the A-phase command voltage (v*_{A}) is positive, the switching pattern (SW_{A}^{AC}) for operating the DC to AC conversion circuit 2 is set to the ON state, and when the A-phase command voltage (v*_{A}) is negative, the switching pattern (SW_{A}^{AC}) for operating the DC to AC conversion, circuit 2 is set to the OFF state. In a case where the A-phase flag is in the OFF state, the A-phase command voltage (v*_{A}) and the carrier (the above-mentioned carrier A) are compared to each other. When the A-phase command voltage (v*_{A}) is higher than the carrier A, the switching pattern (SW_{A}^{AC}) for operating the DC to AC conversion circuit 2 is set to the ON state, and when the A-phase command voltage (v*_{A}) is lower than the carrier A, the switching pattern (SW_{A}^{AC}) for operating the DC to AC conversion circuit 2 is set to the OFF state.

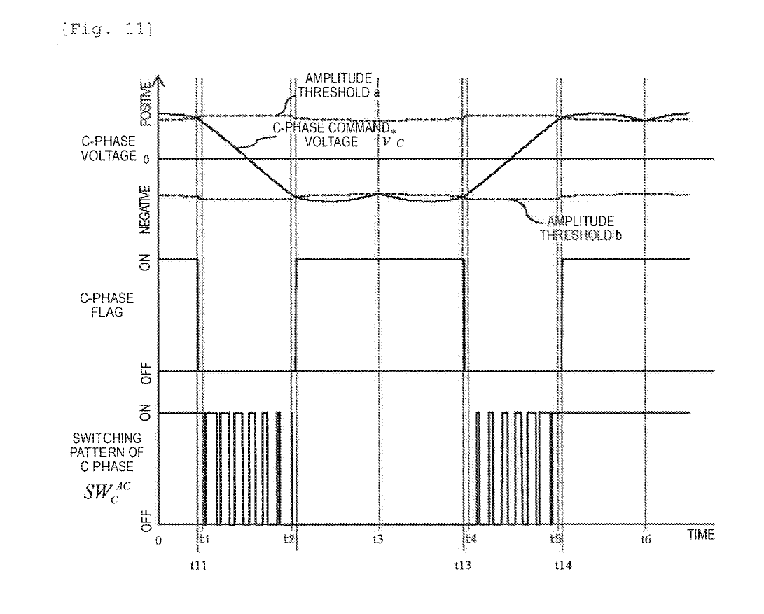

FIG. 10 is a time chart illustrating the summary of operating states of the B phase of the switching pattern calculation 47 in the first embodiment of the power conversion apparatus of the present invention. The horizontal axis of FIG. 10 represents time, and the vertical axis thereof represents a B-phase voltage, a B-phase flag, and a switching pattern (SW_{B}^{AC}) for operating the DC to AC conversion circuit 2 in the B phase. The upper parts of the chart respectively represent that the B-phase voltage is positive, the B-phase flag is in the ON state, and the switching pattern (SW_{B}^{AC}) is in the ON state. As illustrated in the upper section of FIG. 10, in the switching pattern calculation 47, the amplitude threshold a and the amplitude threshold b are calculated from the amplitude threshold 1 (Aₜₕ). A value equal to the amplitude threshold 1 (Aₜₕ) is set to the amplitude threshold a, and a value obtained by inverting the sign of the amplitude threshold 1 (Aₜₕ) is set to the amplitude threshold b. In the switching pattern calculation 47, the B-phase flag which is set to the ON state in a case where the absolute value of a B-phase command voltage (v*_{B}) is higher than the absolute values of the amplitude threshold a and the amplitude threshold b is calculated. By using the B-phase flag, in a case where the B-phase flag is in the ON state, when the B-phase command voltage (v*_{B}) is positive, the switching pattern (SW_{B}^{AC}) for operating the DC to AC conversion circuit 2 is set to the ON state, and when the B-phase command voltage (v*_{B}) is negative, the switching pattern (SW_{A}^{AC}) for operating the DC to AC conversion circuit 2 is set to the OFF state. In a case where the B-phase flag is in the OFF state, the B-phase command voltage (v*_{B}) and the carrier (the above-mentioned carrier A) are compared to each other. When the B-phase command voltage (v_{B}) is higher than the carrier A, the switching pattern (SW_{B}^{AC}) for operating the DC to AC conversion circuit 2 is set to the ON state, and when the B-phase command voltage (v*_{B}) is lower than the carrier A, the switching pattern (SW_{B}^{AC}) for operating the DC to AC conversion circuit 2 is set to the OFF state.

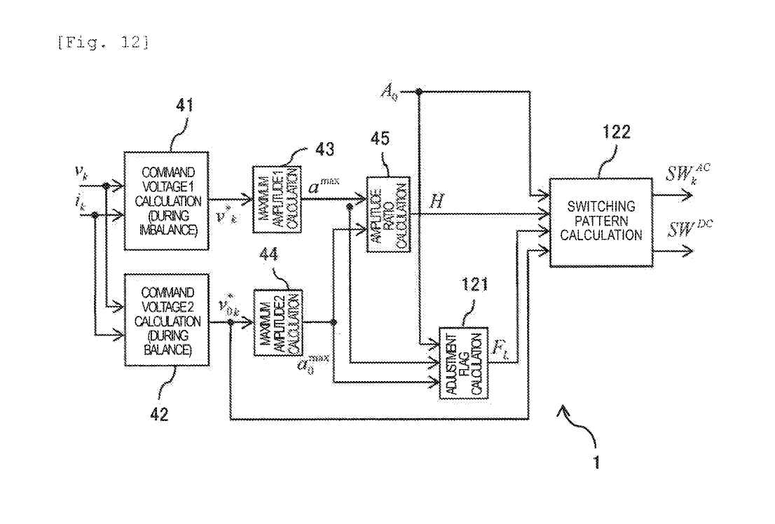

FIG. 11 is st time chart illustrating the summary of operating states of the C phase of the switching pattern calculation 47 in the first embodiment of the power conversion apparatus of the present invention. The horizontal axis of FIG. 11 represents time, and the vertical axis thereof represents a C-phase voltage, a C-phase flag, and a switching pattern (SW_{C}^{AC}) for operating the DC to AC conversion circuit 2 in the C phase. The upper parts of the chart respectively represent that the C-phase voltage is positive, the C-phase flag is in the ON state, and the switching pattern (SW_{C}^{AC}) is in the ON state. As illustrated in the upper section of FIG. 11, in the switching pattern calculation 47, the amplitude threshold a and the amplitude threshold b are calculated from the amplitude threshold 1 (Aₜₕ). A value equal to the amplitude threshold 1 (Aₜₕ) is set to the amplitude threshold a, and a value obtained by inverting the sign of the amplitude threshold 1 (Aₜₕ) is set to the amplitude threshold b. In the switching pattern calculation 47, the C-phase flag which is set to the ON state in a case where the absolute value of a C-phase command voltage (v*_{C}) Is higher than the absolute values of the amplitude threshold a and the amplitude threshold b is calculated. By using the C-phase flag, in a case where the C-phase flag is in the ON state, when the C-phase command voltage (v*_{C}) is positive, the switching pattern (SW_{C}^{AC}) for operating the DC to AC conversion circuit 2 is set to the ON state, and when the C-phase command voltage (v*_{C}) is negative, the switching pattern (SW_{C}^{AC}) for operating the DC to AC conversion circuit 2 is set to the OFF state. In a case where the C-phase flag is in the OFF state, the C-phase command voltage (v*_{C}) and the carrier (the above-mentioned carrier A) are compared to each other. When the C-phase command voltage (v*_{C}) is higher than the carrier A, the switching pattern (SW_{C}^{AC}) for operating the DC to AC conversion circuit 2 is set to the ON state, and when the C-phase command voltage (v*_{C}) is lower than the carrier A, the switching pattern (SW_{C}^{AC}) for operating the DC to AC conversion circuit 2 is set to the OFF state.

In addition, in the switching pattern calculation 47, the maximum amplitude 2 (a₀^{max}) illustrated in FIG. 8 and the carrier (the above-mentioned carrier B) are compared to each other. When the maximum amplitude 1 (a₀^{max}) is higher than the carrier B, the switching pattern (SWₖ^{AC}) for operating the DC voltage conversion circuit 3 is set to the ON state, and when the maximum amplitude 1 (a₀^{max}) is lower than the carrier B, the switching pattern (SW^{DC}) for operating the DC voltage conversion circuit 3 is set to the OFF state.

### Second Embodiment

### Schematic Configuration of Second Embodiments

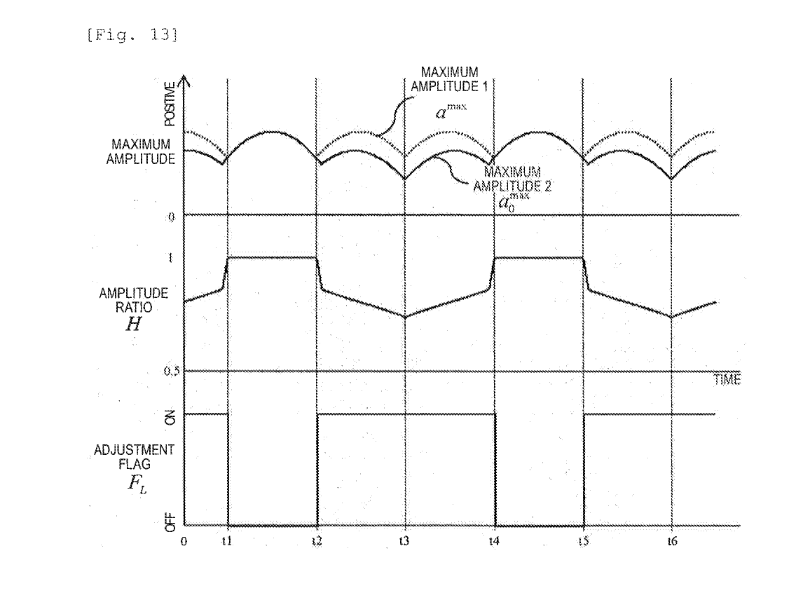

Next, another example of the operations of the power conversion apparatus 101 will be described with reference to FIGS. 12 to 16.

The power conversion apparatus 101 in the second embodiment has the configuration illustrated in FIG. 1 as in the first embodiment, and thus the description thereof will be omitted.

### Description of Operations of Power Conversion Apparatus in Second Embodiment

Next, the example of the operations of the power conversion apparatus 101 will be described with reference to FIGS. 12 to 16.

FIG. 12 illustrates a block diagram of a control algorithm mounted in the control device 1 of the power conversion apparatus 101.

The control algorithm in the second embodiment is formed by the command voltage 1 calculation 41, the command voltage 2 calculation 42, the maximum amplitude 1 calculation 43, the maximum amplitude 2 calculation 44, the amplitude ratio calculation 45, an adjustment flag calculation 121, and a switching pattern calculation 122.

The command voltage 1 calculation 41, the command voltage 2 calculation 42, the maximum amplitude 1 calculation 43, the maximum amplitude 2 calculation 44, and the amplitude ratio calculation 45 are the same as those of the first embodiment described above, and thus the description thereof will be omitted.

In this embodiment, as in the first embodiment, a case where only the maximum amplitude of the C phase voltage among the three-phase voltages of the AC voltage system 8 is low is postulated. Therefore, the command voltage 1 (v*ₖ), the command voltage 2 (v*₀ₖ), the amplitude threshold 1 (Aₜₕ), and the amplitude threshold 2 (A₀) are as illustrated in FIGS. 5 and 6.

The adjustment flag calculation 121 calculates an adjustment flag (F_{L}) on the basis of the above-described command voltage 2 (v*₀ₖ), the maximum amplitude 1 (a^{max}), the maximum amplitude 2 (a₀^{max}), and the above-described amplitude threshold 2 (A₀) during three-phase balance. In a case where there is a difference between the maximum amplitude 1 (a^{max}) and the maximum amplitude 2 (a₀^{max}), the adjustment flag (F_{L}) is set to the ON state, and in a case where the maximum amplitude 1 (a^{max}) and the maximum amplitude 2 (a₀^{max}) are equal to each other, the adjustment flag (F_{L}) is set to the OFF state.

The switching pattern calculation 122 calculates a switching pattern (SWₖ^{AC}) for operating the DC to AC conversion circuit 2 and a switching pattern (SW^{DC}) for operating the DC voltage conversion circuit 3 on the basis of the amplitude threshold 2 (A₀), the amplitude ratio (H), the adjustment flag (F_{L}), and the command voltage 2 (v*₀ₖ) in a case where the three-phase balance is postulated. On the basis of the operating states of the flag for each of the phases and the adjustment flag (F_{L}), which will be described below, in a case where the flag for each of the phases is in the OFF state, the command voltage 2 (v*₀ₖ) for each of the phases and a carrier (carrier A1) for operating the DC to AC conversion circuit 2 are compared to each other to determine the switching pattern SWₖ^{AC}). Under the conditions of a case where the flag for each of the phases is in the ON state and the adjustment flag (F_{L}) is in the OFF state, when the command voltage 2 (v*₀ₖ) is positive, the switching pattern (SWₖ^{AC}) is set to the ON state, and when the command voltage 2 (v*₀ₖ) is negative, the switching pattern (SWₖ^{AC}) is set to the OFF state. Furthermore, under the conditions of a case where the flag for each of the phases is in the ON state and the adjustment flag (F_{L}) is in the ON state, when the command voltage 2 (v*₀ₖ) is positive, by comparing a value obtained by subtracting a difference between an amplitude threshold a0 determined from the amplitude threshold 1 (Aₜₕ) and the amplitude threshold 2 (A₀), and an amplitude threshold a1 from the amplitude threshold a0 to the carrier A, the switching pattern (SWₖ^{AC}) is set to the ON state and the OFF state. Moreover, under the conditions of the case where the flag for each of the phases is in the ON state and the adjustment flag (F_{L}) is in the ON state, when the command voltage 2 (v*₀ₖ) is negative, by comparing a value obtained by adding a difference between an amplitude threshold b0 determined from the amplitude threshold 1 (Aₜₕ) and the amplitude threshold 2 (A₀), and an amplitude threshold b1 to the amplitude threshold b0 to the carrier A, the switching pattern (SWₖ^{AC}) is set to the ON state and the OFF state.

In addition, in the switching pattern calculation 122, the switching pattern (SW^{DC}) is determined by comparing the maximum amplitude 2 (a₀^{max}) when the three-phase balance is simulated and a carrier (carrier B1) for operating the DC voltage conversion circuit 3. In a case where the maximum amplitude 2 (a₀^{max}) is higher than the carrier B1, the switching pattern (SW^{DC}) is set to the ON state, and in a case where the maximum amplitude 2 (a₀^{max}) is lower than the carrier B1, the switching pattern (SW^{DC}) is set to the OFF state.

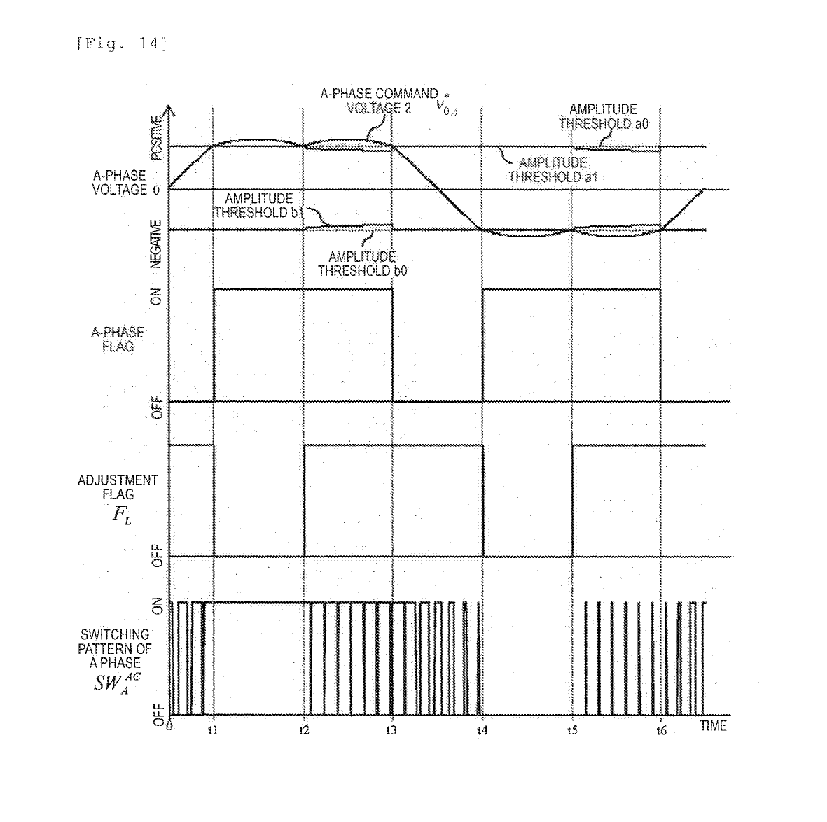

FIG. 13 is a time chart illustrating the summary of operating states of the amplitude ratio calculation 45 and the adjustment flag calculation 121 in the second embodiment of the power conversion apparatus of the present invention. The horizontal axis of FIG. 13 represents time, and the vertical axis of FIG. 13 represents the maximum amplitude, the amplitude ratio (H), and the adjustment flag (F_{L}). The upper parts of the chart respectively represent that the maximum amplitude is positive, the amplitude ratio is 1, and the adjustment flag is in the ON state. As in the first embodiment, in the amplitude ratio calculation 45, the maximum amplitude 1 (a^{max}) and the maximum amplitude 2 (a₀^{max}) are transited, and by dividing the former by the latter, the amplitude ratio (H) is determined. The adjustment flag calculation 121 compares the maximum amplitude 1 (a^{max}) and the maximum amplitude 2 (a₀^{max}) to each other. In a case where there is a difference therebetween, the adjustment flag (F_{L}) is set to the ON state, and in a case where there is no difference therebetween and the two are the same, the adjustment flag (F_{L}) is set to the OFF state.

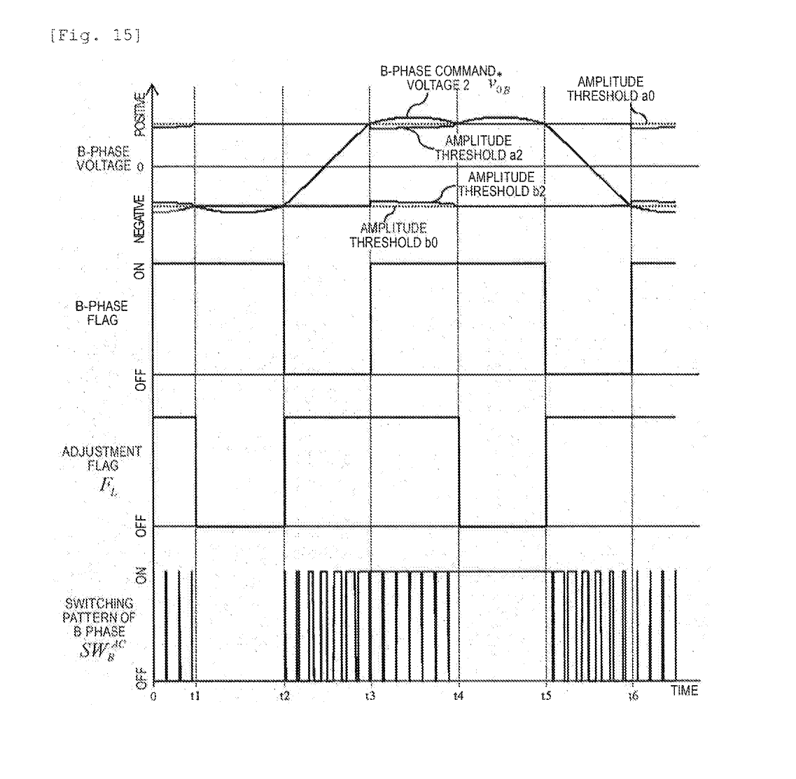

FIG. 14 is a time chart illustrating the summary of operating states of the A phase of the switching pattern calculation 122. The horizontal axis of FIG. 14 represents time, and the vertical axis thereof represents the A-phase voltage, the A-phase flag, the adjustment flag (F_{L}), and the switching pattern (SW_{A}^{AC}) for operating the DC to AC conversion circuit 2 in the A phase. The upper parts of the chart respectively represent that the A-phase voltage is positive, the A-phase flag is in the ON state, the adjustment flag (F_{L}) is in the ON state, and the switching pattern (SW_{A}^{AC}) is in the ON state. Regarding the A-phase flag illustrated in the intermediate section of FIG. 14, the amplitude threshold a0 which has a value equal to the amplitude threshold 2 (A₀), the absolute value of the amplitude threshold b0 which is obtained by inverting the sign of the amplitude threshold 2 (A₀), and the absolute value of an A-phase command voltage 2 (v*_{0A}) are compared to each other. In a case where the absolute value of the A-phase command voltage 2 (v*_{0A}) is higher, the A-phase flag is set to the ON state, and in a case where the absolute value thereof is lower, the A-phase flag is set to the OFF state. In addition, regarding the amplitude threshold a1 in the upper section of FIG. 14, an AND operation of the A-phase flag and the adjustment flag (F_{L}) is performed. In a case where the result is ON, a value obtained by multiplying the amplitude threshold a0 by the amplitude ratio H is set to the amplitude threshold a1, and in a case where the result is OFF, the same value as that of the amplitude threshold a0 is set to the amplitude threshold a1. In the same manner, regarding the amplitude threshold b1, an AND operation of the A-phase flag and the adjustment flag (F_{L}) is performed. In a case where the result is ON, a value obtained by multiplying the amplitude threshold b0 by the amplitude ratio H is set to the amplitude threshold b1, and in a case where the result is OFF, the same value as that of the amplitude threshold b0 is set to the amplitude threshold b1. Furthermore, as illustrated in the lowest section of FIG. 14, in the switching pattern calculation 122, under conditions in which the adjustment flag (F_{L}) is in the OFF state, when the sign of the A-phase command voltage 2 (v*_{0A}) is positive, the switching pattern (SW_{A}^{AC}) is set to the ON state, and when the sign of the A-phase command voltage 2 (v*_{0A}) is negative, the switching pattern (SW_{A}^{AC}) is set to the OFF state. In addition, in a case where the A-phase flag is in the OFF state and the adjustment flag (F_{L}) is in the ON state, the A-phase command voltage 2 (v*_{0A}) and a carrier (carrier C) having an amplitude obtained by subtracting the amplitude threshold b0 from the amplitude threshold a0 are compared to each other. When the A-phase command voltage 2 (v*_{0A}) is higher than the carrier C, the switching pattern (SW_{A}^{AC}) is set to the ON state, and when the A-phase command voltage 2 (v′_{0A}) is lower than the carrier C, the switching pattern (SW_{A}^{AC}) is set to the OFF state. Furthermore, in a case where the A-phase flag is in the ON state and the adjustment flag (F_{L}) is in the ON state, when the sign of the A-phase command voltage 2 (v*_{0A}) is positive, the amplitude threshold a1 and the carrier C are compared to each other. When the amplitude threshold a1 is higher than the carrier C, the switching pattern (SW_{A}^{AC}) is set to the ON state, and when the amplitude threshold a1 is lower than the carrier C, the switching pattern (SW_{A}^{AC}) is set to the OFF state. In the case where the A-phase flag is in the OK state and the adjustment flag (F_{L}) is in the ON state, when the sign of the A-phase command voltage 2 (v*_{0A}) is negative, the amplitude threshold b1 and the carrier C are compared to each other. When the amplitude threshold b1 is higher than the carrier C, the switching pattern (SW_{A}^{AC}) is set to the ON state, and when the amplitude threshold b1 is lower than the carrier C, the switching pattern (SW_{A}^{AC}) is set to the OFF state.

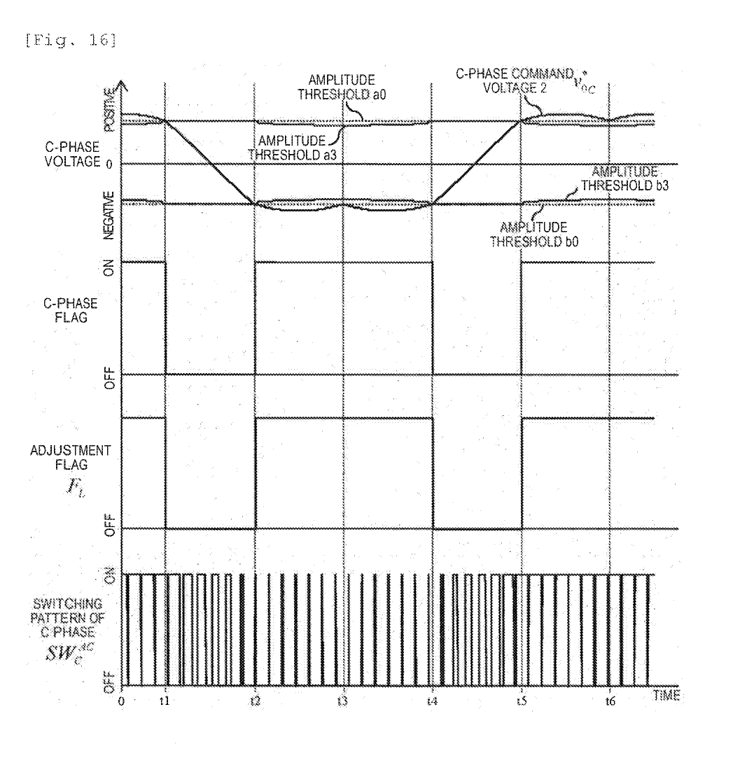

FIG. 15 is a time chart illustrating the summary of operating states of the B phase of the switching pattern calculation 122. The horizontal axis of FIG. 15 represents time, and the vertical axis thereof represents the B-phase voltage, the B-phase flag, the adjustment flag (F_{L}), and the switching pattern (SW_{B}^{AC}) for operating the DC to AC conversion circuit 2 in the B phase. The upper parts of the chart, respectively represent that the B-phase voltage is positive, the B-phase flag is in the ON state, the adjustment flag (F_{L}) is in the ON state, and the switching pattern (SW_{B}^{AC}) is in the ON state. Regarding the B-phase flag illustrated in the intermediate section of FIG. 15, the amplitude threshold a0 which has a value equal to the amplitude threshold 2 (A₀, the absolute value of the amplitude threshold b0 which is obtained by inverting the sign of the amplitude threshold 2 (A₀), and the absolute value of a B-phase command voltage 2 (v*_{0B}) are compared to each other. In a case where the absolute value of the B-phase command voltage 2 (v*_{0B}) is higher, the B-phase flag is set to the ON state, and in a case where the absolute value thereof is lower, the B-phase flag is set to the OFF state. In addition, regarding the amplitude threshold a2 in the upper section of FIG. 15, an AND operation of the B-phase flag and the adjustment flag (F_{L}) is performed. In a case where the result is OK, a value obtained by multiplying the amplitude threshold a0 by the amplitude ratio H is set to the amplitude threshold a2, and in a case where the result is OFF, the same value as that of the amplitude threshold a0 is set to the amplitude threshold a2. In the same manner, regarding the amplitude threshold b2, an AND operation of the B-phase flag and the adjustment flag (F_{L}) is performed. In a case where the result is ON, a value obtained by multiplying the amplitude threshold b0 by the amplitude ratio H is set to the amplitude threshold b2, and in a case where the result is OFF, the same value as that of the amplitude threshold b0 is set to the amplitude threshold b2. Furthermore, as illustrated in the lowest section of FIG. 15, in the switching pattern calculation 122, under the conditions in which the adjustment flag (F_{L}) is in the OFF state, when the sign of the B-phase command voltage 2 (v*_{0B}) is positive, the switching pattern (SW_{B}^{AC}) is set to the ON state, and when the sign of the B-phase command voltage 2 (v*_{0B}) is negative, the switching pattern (SW_{B}^{AC}) is set to the OFF state. In addition, in a case where the B-phase flag is in the OFF state and the adjustment flag (F_{L}) is in the ON state, the B-phase command voltage 2 (v*_{0B}) and the carrier (carrier C) having an amplitude obtained by subtracting the amplitude threshold b0 from the amplitude threshold a0 are compared to each other. When the B-phase command voltage 2 (v*_{0B}) is higher than the carrier C, the switching pattern (SW_{B}^{AC}) is set to the ON state, and when the B-phase command voltage 2 (v′_{OB}) is lower than the carrier C, the switching pattern (SW_{B}^{AC}) is set to the OFF state. Furthermore, in a case where the B-phase flag is in the ON state and the adjustment flag (F_{L}) is in the ON state, when the sign of the B-phase command voltage 2 (v*_{0B}) is positive, the amplitude threshold a2 and the carrier C are compared to each other. When, the amplitude threshold a2 is higher than the carrier C, the switching pattern (SW_{B}^{AC}) is set to the ON state, and when the amplitude threshold a2 is lower than the carrier C, the switching pattern (SW_{B}^{AC}) is set to the OFF state. In the case where the B-phase flag is in the ON state and the adjustment flag (F_{L}) is in the ON state, when the sign of the B-phase command voltage 2 (v*_{0B}) is negative, the amplitude threshold b2 and the carrier C are compared to each other. When the amplitude threshold b2 is higher than the carrier C, the switching pattern (SW_{B}^{AC}) is set to the ON state, and when the amplitude threshold b2 is lower than the carrier C, the switching pattern (SW_{B}^{AC}) is set to the OFF state.

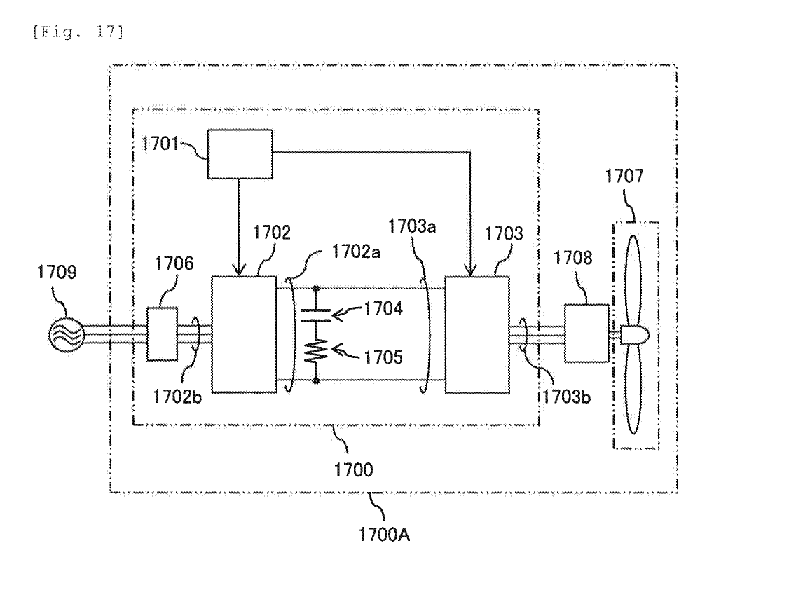

FIG. 16 is a time chart illustrating the summary of operating states of the C phase of the switching pattern calculation 122. The horizontal axis of FIG. 16 represents time, and the vertical axis thereof represents the C-phase voltage, the C-phase flag, the adjustment flag (F_{L}), and the switching pattern (SW_{C}^{AC}) for operating the DC to AC conversion circuit 2 in the C phase. The upper parts of the chart respectively represent that the C-phase voltage is positive, the C-phase flag is in the ON state, the adjustment flag (F_{L}) is in the ON state, and the switching pattern (SW_{C}^{AC}) is in the ON state. Regarding the C-phase flag illustrated in the intermediate section of FIG. 16, the amplitude threshold a0 which has a value equal to the amplitude threshold 2 (A₀), the absolute value of the amplitude threshold b0 which is obtained by inverting the sign of the amplitude threshold 2 (A*_{0C}), and the absolute value of a C-phase command voltage 2 (v*_{0C}) are compared to each other. In a case where the absolute value of the C-phase command voltage 2 (v*_{0C}) is higher, the C-phase flag is set to the ON state, and in a case where the absolute value thereof is lower, the C-phase flag is set to the OFF state. In addition, regarding the amplitude threshold a3 in the upper section of FIG. 16, an AND operation of the C-phase flag and the adjustment flag (F_{L}) is performed. In a case where the result is ON, a value obtained by multiplying the amplitude threshold a0 by the amplitude ratio H is set to the amplitude threshold a3, and in a case where the result is OFF, the same value as that of the amplitude threshold a0 is set to the amplitude threshold a3. In the same manner, regarding the amplitude threshold b3, an AND operation of the B-phase flag and the adjustment flag (F_{L}) is performed. In a case where the result is ON, a value obtained by multiplying the amplitude threshold b0 by the amplitude ratio H is set to the amplitude threshold b3, and in a case where the result is OFF, the same value as that of the amplitude threshold b0 is set to the amplitude threshold b3. Furthermore, as illustrated in the lowest section of FIG. 16, in the switching pattern calculation 122, under the conditions in which the adjustment flag (F_{L}) is in the OFF state, when the sign of the C-phase command voltage 2 (v*_{0C}) is positive, the switching pattern (SW_{C}^{AC}) is set to the ON state, and when the sign of the C-phase command voltage 2 (v*_{0C}) is negative, the switching pattern (SW_{C}^{AC}) is set to the OFF state. In addition, in a case where the C-phase flag is in the OFF state and the adjustment flag (F_{L}) is in the ON state, the C-phase command voltage 2 (v*_{0C}) and the carrier (carrier C) having an amplitude obtained by subtracting the amplitude threshold b0 from the amplitude threshold a0 are compared to each other. When the C-phase command voltage 2 (v*_{0C}) is higher than the carrier C, the switching pattern (SW_{C}^{AC}) is set to the ON state, and when the C-phase command voltage 2 (v_{0C}) is lower than the carrier C, the switching pattern (SW_{C}^{Ac}) is set to the OFF state. Furthermore, in a case where the C-phase flag is in the ON state and the adjustment flag (F_{L}) is in the ON state, when the sign of the C-phase command voltage 2 (v*_{0C}) is positive, the amplitude threshold a3 and the carrier C are compared to each other. When the amplitude threshold a3 is higher than the carrier C, the switching pattern (SW_{C}^{AC}) is set to the ON state, and when the amplitude threshold a3 is lower than the carrier C, the switching pattern (SW_{C}^{AC}) is set to the OFF state. In the case where the C-phase flag is in the ON state and the adjustment flag (F_{L}) is in the ON state, when the sign of the C-phase command voltage 2 (v*_{0C}) is negative, the amplitude threshold b3 and the carrier C are compared to each other. When the amplitude threshold b3 is higher than the carrier C, the switching pattern (SWa_{C}^{AC}) is set to the ON state, and when the amplitude threshold b3 is lower than the carrier C, the switching pattern (SW_{C}^{AC}) is set to the OFF state.

### Third Embodiment

### Schematic Configuration of Third Embodiment

In the two embodiments described above, the examples of the operating states in the case where the power conversion apparatus 101 is provided in the power system 102 are described. In the above description, the example in which the power conversion apparatus 101 is configured to include the DC to AC conversion circuit 2 and the DC voltage conversion circuit 3 is described. However, the present invention is not limited thereto, and as illustrated in a power conversion apparatus 1700 illustrated in FIG. 17, a configuration in which the DC side terminal of a DC to AC conversion circuit 1703 is connected to the DC side terminal of a DC to AC conversion circuit 1702 may be employed. The DC side terminals 1702a and 1703a of the DC to AC conversion circuits 1702 and 1703, a string having a capacitor 1704 and a resistor 1705 connected in series is connected in parallel. In addition, a filter 1706 is connected to an AC side terminal 1702b of the DC to AC conversion circuit 1702. Furthermore, the power conversion apparatus 1700 includes a control device 1701. An electrical connection terminal of a generator 1708 connected to a rotor 1707 which converts wind power energy into rotational energy is connected to an AC side terminal 1703b of the DC to AC conversion circuit 1703 of the power conversion apparatus 1700. In addition, the filter 1706 is connected to an AC voltage system 1709. The configuration illustrated in FIG. 17 is for configuring a wind-power generation system 1700A. Examples of operating states of the power conversion apparatus 1700 controlled by the control device 1701 are the same as those of the first and second embodiments described above, and thus the description thereof will be omitted.

### Conclusions

The power conversion apparatus of each of the embodiments described above is a power conversion apparatus including: a DC to AC conversion circuit which enables conversion between a DC voltage and an AC voltage, in which the power conversion apparatus periodically changes a magnitude of a DC voltage which is a voltage of a DC side connection end of the DC to AC conversion circuit according to a period of a voltage of an AC voltage system connected to an AC side connection end of the DC to AC conversion circuit, and allows a portion of an AC voltage which is a voltage of the AC side connection end to be substituted with the periodic change in the DC voltage so as to be output, and the DC voltage is controlled according to a voltage of a phase having the highest successive amplitude among three-phase AC voltages which are voltages of the AC voltage system. In this configuration, a power conversion apparatus capable of enhancing the efficiency of the power conversion apparatus by reducing power loss caused by switching operations of the power conversion apparatus while adjusting voltages and currents output according to three-phase imbalance of the power system interconnected with the power conversion apparatus can be provided.

As described in the third embodiment, a circuit configuration in which two DC to AC conversion circuits are provided and DC connection ends of the DC to AC conversion circuits are connected to each other to enable conversion between an AC voltage and an AC voltage may also be provided. As described in the first embodiment, a circuit configuration in which a DC to DC conversion circuit that is able to convert a DC voltage into a DC voltage is connected to the DC connection end of the DC to AC conversion circuit to enable conversion between a DC voltage and an AC voltage may also be provided.

It is preferable that the DC voltage which is periodically changed is determined on the basis of the three-phase AC voltages of the AC voltage system and is controlled on the basis of, among three-phase components of an absolute value of an AC voltage target value which is a target value of the AC voltage, the absolute value of the AC voltage target value which is successively maximized. It is ideal to perform control in a direction that matches the absolute value.

In addition, an amplitude of the DC voltage which is periodically changed is changed on the basis of active power transmitted between the DC to AC conversion circuit and the AC voltage system. In addition, the amplitude of the DC voltage which is periodically changed is increased as the active power transmitted between the DC to AC conversion circuit and the AC voltage system is increased.

In each of the embodiments, when there is a difference between the phases of the system voltages in amplitude, phase, or amplitude and phase, the number of switching operations which is the number of switching operations when the DC to AC conversion circuit performs conversion between DC and AC is changed between the phases according to a successive amplitude difference between the phases with respect to an amplitude of a phase in which the amplitude of the three-phase AC voltage of the AC voltage system is successively maximized.

The power conversion apparatus allows a portion of the AC voltage of the DC to AC conversion circuit to be substituted with the DC voltage of the DC to AC conversion circuit by periodically changing the DC voltage according to a phase in which a maximum value of the amplitude of the system voltage is maximized, when there is a difference between the phases of the three-phase AC voltages of the AC voltage system in amplitude, phase, or amplitude and phase and the number of switching operations of the DC to AC conversion circuit is changed between the phases according to the difference between the phases of the maximum values of the successive amplitudes of the three-phase AC voltages of the AC voltage system, a successive amplitude of a phase A in which the maximum value of the amplitude of the three-phase AC voltage of the AC voltage system is the highest among the three phases is referred to as a reference successive amplitude, and in the phases other than the phase A, as the difference between the reference successive amplitude and successive amplitudes of the phases is increased, the number of switching operations is more than the number of switching operations of the phase of the reference successive amplitude, thereby obtaining greater effects.

### REFERENCE SIGNS LIST

1 Control Device
2 DC to AC Conversion Circuit
2a, 2b, 2c, 2d, 2e, 2f Pair of Switches
3 DC Voltage Conversion Circuit
4 Capacitor
5 Resistor
6 Filter Circuit
7 DC Power Source Device
8 AC Voltage System
21 AC Side Terminal
22 DC Side Terminal
32 Terminal
33 Connection Terminal
41 Command Voltage 1 Calculation
42 Command Voltage 2 Calculation
43 Maximum Amplitude 1 Calculation
44 Maximum Amplitude 2 Calculation
45 Amplitude Ratio Calculation
46 Amplitude Threshold 1 Calculation
47 Switching Pattern Calculation
101 Power Conversion Apparatus
102 Power System
121 Adjustment Flag Calculation
122 Switching Pattern Calculation
1700 Power Conversion Apparatus
1700A Wind-Power Generation System
1701 Control Device
1702, 1703 DC to AC Conversion Circuit
1704 Capacitor
1705 Resistor
1706 Filter Circuit
1707 Rotor
1708 Generator
1709 AC Voltage System

1. A power conversion apparatus comprising:
a DC to AC conversion circuit which enables conversion between a DC voltage and an AC voltage,
wherein the power conversion apparatus periodically changes a magnitude of a DC voltage which is a voltage of a DC side connection end of the DC to AC conversion circuit according to a period of a voltage of an AC voltage system connected to an AC side connection end of the DC to AC conversion circuit, and allows a portion of an AC voltage which is a voltage of the AC side connection end to be substituted with the periodic change in the DC voltage so as to be output, and
the DC voltage is controlled according to a voltage of a phase having a highest successive amplitude among three-phase AC voltages which are voltages of the AC voltage system.

2. The power conversion apparatus according to claim 1,
wherein the DC voltage which is periodically changed is determined on the basis of the three-phase AC voltages of the AC voltage system and is controlled on the basis of, among three-phase components of an absolute value of an AC voltage target value which is a target value of the AC voltage, the absolute value of the AC voltage target value which is successively maximized.

3. The power conversion apparatus according to claim 1,
wherein an amplitude of the DC voltage which is periodically changed is changed on the basis of active power transmitted between the DC to AC conversion circuit and the AC voltage system.

4. The power conversion apparatus according to claims 1,
wherein the amplitude of the DC voltage which is periodically changed is increased as the active power transmitted between the DC to AC conversion circuit and the AC voltage system is increased.

5. The power conversion apparatus according to claims 1,
wherein, when there is a difference between the phases of the system voltages in amplitude, phase, or amplitude and phase, the number of switching operations which is the number of switching operations when the DC to AC conversion circuit performs conversion between DC and AC is changed between the phases according to a successive amplitude difference between the phases with respect to an amplitude of a phase in which the amplitude of the three-phase AC voltage of the AC voltage system is successively maximized.

6. The power conversion apparatus according to claim 5,
wherein the power conversion apparatus allows a portion of the AC voltage of the DC to AC conversion circuit to be substituted with the DC voltage of the DC to AC conversion circuit by periodically changing the DC voltage according to a phase in which a maximum value of the amplitude of the system voltage is maximized,
when there is a difference between the phases of the three-phase AC voltages of the AC voltage system in amplitude, phase, or amplitude and phase and the number of switching operations of the DC to AC conversion circuit is changed between the phases according to the difference between the phases of the maximum values of the successive amplitudes of the three-phase AC voltages of the AC voltage system, a successive amplitude of a phase A in which the maximum value of the amplitude of the three-phase AC voltage of the AC voltage system is highest among the three phases is referred to as a reference successive amplitude, and
in the phases other than the phase A, as the difference between the reference successive amplitude and successive amplitudes of the phases is increased, the number of switching operations is more than the number of switching operations of the phase of the reference successive amplitude.

7. The power conversion apparatus according to claims 1,
wherein a circuit configuration in which two DC to AC conversion circuits are provided and DC connection ends of the DC to AC conversion circuits are connected to each other to enable conversion between an AC voltage and an AC voltage is provided.

8. The power conversion, apparatus according to claims 1,
wherein a circuit configuration in which a DC to DC conversion circuit that is able to convert a DC voltage into a DC voltage is connected to the DC connection end of the DC to AC conversion circuit to enable conversion between a DC voltage and an AC voltage is provided.
